(19) United States
(12) Patent Application Publication
(10) Pub. No.: US 2023/0214757 A1
(43) Pub. Date: Jul. 6, 2023

(54) OPTIMIZATION PROCESSING APPARATUS, OPTIMIZATION PROCESSING METHOD, AND COMPUTER READABLE RECORDING MEDIUM

(71) Applicant: NEC Corporation, Minato-ku, Tokyo (JP)

(72) Inventor: Kei TAKEMURA, Tokyo (JP)

(73) Assignee: NEC Corporation, Minato-ku, Tokyo (JP)

(21) Appl. No.: 17/928,366

(22) PCT Filed: Jun. 1, 2020
(86) PCT No.: PCT/JP2020/021630

§ 371 Date: Nov. 29, 2022

(51) Int. Cl. G06Q 10/0639

(52) U.S. Cl. CPC G06Q 10/06398

(57) ABSTRACT

The optimization processing apparatus is an apparatus for assigning actions on a per-user basis. The optimization processing apparatus includes: a data obtainment unit that obtains constraint information on a per-action basis and user information on a per-user basis; a gain function estimation unit estimates, for each user, a prediction function and a reliability degree function based on the constraint information and the user information, and estimates a gain function from the prediction function and the reliability degree function; and an assignment processing unit that assigns the actions on a per-user basis based on the estimated gain functions. The gain function estimation unit corrects, for each user, the gain function of the user in a case where a set condition is satisfied.

### TECHNICAL FIELD

The present invention relates to an optimization processing apparatus and an optimization processing method for optimizing an action to be assigned to a user, and further relates to a program for realizing them.

### BACKGROUND ART

Non-Patent Document 1 discloses a method for performing optimization so as to earn the maximum gain with use of an algorithm based on contextual combinatorial bandits, which represent one type of the multi-armed bandit problem. The method disclosed in Non-Patent Document 1 is used in, for example, determining contents to be recommended to a user on an online application, such as a movie distribution site. Also, Non-Patent Document 1 suggests a recommendation system that recommends a plurality of movies to a user with use of this method.

Specifically, the system disclosed in Non-Patent Document 1 optimizes movies to be recommended to each user so as to maximize the profit that a movie distribution company can receive in a case where there are several movies to be recommended to a plurality of users.

In order to achieve this optimization, the system disclosed in Non-Patent Document 1 first estimates, for each user, a prediction function for predicting the gain that is earned when movies are recommended to that user based on a feature vector of that user and constraint conditions of each movie, as well as a reliability degree function for deriving a reliability degree of the result of prediction made by the prediction function. Next, the system disclosed in Non-Patent Document 1 obtains a gain function for each user by combining the prediction function and the reliability degree function of that user. The gain function is a function indicating the gain that is earned when movies are recommended to that user.

Then, using the gain functions that have been estimated for respective users, the system disclosed in Non-Patent Document 1 determines movies to be recommended to the users so as to maximize the gain, that is to say, the profit that the movie distribution company can receive.

### LIST OF RELATED ART DOCUMENTS

### Non Patent Document

Non-Patent Document 1: L. Qin, S. Chen, and X. Zhu, “Contextual Combinatorial Bandit and its Application on Diversified Online Recommendation”, in Proceedings of the 2014 SIAM International Conference on Data Mining, pp. 461-469, 2014

### SUMMARY OF INVENTION

### Problems to be Solved by the Invention

However, in the above-described system disclosed in Non-Patent Document 1, a reliability degree function that composes a gain function is estimated optimistically, that is to say, so that the reliability degree becomes high in the case of an uncertain option. For this reason, the above-described system disclosed in Non-Patent Document 1 has a possibility of incurring a situation where movies that actually increase the profit cannot be recommended.

An example object of the present invention is to provide an optimization processing apparatus, an optimization processing method, and a computer readable recording medium that can solve the aforementioned problem and increase the accuracy of optimization at the time of assignment of an action to a user.

### Means for Solving the Problems

In order to achieve the above-described object, a optimization processing apparatus for assigning actions on a per-user basis, includes:

a data obtainment unit that obtains constraint information on a per-action basis and user information on a per-user basis;

a gain function estimation unit that estimates, for each user, a prediction function and a reliability degree function based on the constraint information and the user information, and estimates a gain function from the estimated prediction function and the reliability degree function, the prediction function predicting a gain earned from the user, the reliability degree function deriving a reliability degree of a result of prediction made by the prediction function, and the gain function indicating a gain earned from the user; and

an assignment processing unit that assigns the actions on a per-user basis based on the estimated gain functions,

wherein

for each user, the gain function estimation unit corrects the gain function of the user in a case where a set condition is satisfied.

In addition, in order to achieve the above-described object, a optimization processing method for assigning actions on a per-user basis, includes:

a data obtainment step of obtaining constraint information on a per-action basis and user information on a per-user basis;

a gain function estimation step of estimating, for each user, a prediction function and a reliability degree function based on the constraint information and the user information, and estimating a gain function from the estimated prediction function and the reliability degree function, the prediction function predicting a gain earned from the user, the reliability degree function deriving a reliability degree of a result of prediction made by the prediction function, and the gain function indicating a gain earned from the user;

a correction step of correcting, for each user, the gain function of the user in a case where a set condition is satisfied; and

an assignment processing step of assigning the actions on a per-user basis based on the estimated gain functions.

Furthermore, in order to achieve the above-described object, a computer readable recording medium according to an example aspect of the invention is a computer readable recording medium that includes recorded thereon a program,

the program being for causing a computer to assign actions on a per-user basis and including instructions that cause the computer to carry out:

a data obtainment step of obtaining constraint information on a per-action basis and user information on a per-user basis;

a gain function estimation step of estimating, for each user, a prediction function and a reliability degree function based on the constraint information and the user information, and estimating a gain function from the estimated prediction function and the reliability degree function, the prediction function predicting a gain earned from the user, the reliability degree function deriving a reliability degree of a result of prediction made by the prediction function, and the gain function indicating a gain earned from the user;

a correction step of correcting, for each user, the gain function of the user in a case where a set condition is satisfied; and

an assignment processing step of assigning the actions on a per-user basis based on the estimated gain functions.

### Advantageous Effects of the Invention

As described above, according to the invention, it is possible to increase the accuracy of optimization at the time of assignment of an action to a user.

### BRIEF DESCRIPTION OF THE DRAWINGS

FIG. 1 is a block diagram showing a schematic configuration of the optimization processing apparatus according to the example embodiment.

FIG. 2 is a block diagram specifically showing the configuration of the optimization processing apparatus according to the example embodiment.

FIG. 3 is a diagram for describing processing for correcting a gain function according to the example embodiment.

FIG. 4 is a flow diagram showing the operations of the optimization processing apparatus according to the example embodiment.

FIG. 5 is a flow diagram that more specifically shows processing for estimating a gain function shown in FIG. 4.

FIG. 6 is a diagram showing an example of application of the optimization processing apparatus according to the example embodiment.

FIG. 7 is a block diagram illustrating an example of a computer that realizes the optimization processing apparatus according to the example embodiment.

### EXAMPLE EMBODIMENT

(Precondition for the Invention)

The present invention optimizes an action to be assigned to a user, for example, a promotion for promoting sales to a user (e.g., distribution of advertisements). Here, assignment of an action means, for example, determining to which user a promotion is to be provided, and to which user a promotion is not to be provided. Furthermore, a user may also be referred to as a candidate in a more general way. Although the contents of an action are not particularly limited, examples of an action include distribution of online advertisements on a browser, transmission of advertisements by electronic mails, transmission of discount coupons by electronic mails, and so on.

Meanwhile, conventionally, there are various types of algorithms that make decisions with use of a gain function (or a reward function). However, in an actual situation of decision making, it is difficult to obtain, ahead of time, a gain function for predicting a gain (e.g., the purchase price, the probability of purchase, the expected value of the purchase price, and the like) from an action (e.g., assignment of a promotion) in a perfect condition.

For example, at the stage where there is no information, it is difficult to both predict the probability that a user who has been targeted for a promotion purchases a product, and predict the probability that a user who has not been targeted for a promotion purchases a product. Also, even if there is a certain amount of information, these probabilities often include errors. For this reason, the execution of an action that has been determined based on a gain function and the obtainment of the execution result are carried out repeatedly; in this way, the accuracy of estimation of a gain function is increased. Furthermore, there is a need for the party who earns a gain to increase the accuracy of estimation of a gain function in order to maximize the gain actually earned.

The multi-armed bandit problem, which has been mentioned in the BACKGROUND ART section, is one of the models that can be applied to a situation where such sequential decision making is required. The multi-armed bandit problem is, for example, a problem of how to maximize the gain as a player repeatedly selects and tries (pulls the arm of) one of slot machines, in a case where there are a plurality of slot machines with which there is no a priori knowledge about how easily they provide wins.

Regarding the multi-armed bandit problem, research has been conducted about an algorithm that maximizes the total gain in consideration of the tradeoff between “exploration” to search for slot machines that easily provide wins and “exploitation” to secure the gain by selecting and trying slot machines that easily provide wins. Furthermore, the multi-armed bandit problem is also applicable to uses other than slot machines, and application thereof to various types of decision making has been considered. Regarding the above-described assignment of a promotion, the multi-armed bandit problem can be applied by replacing the selection of a slot machine with the selection of a user to be targeted for a promotion.

Meanwhile, in the example of slot machines, a slot machine whose arm has not been pulled does not operate, and a gain is not earned therefrom. That is to say, the problem setting is based on the precondition that a player can earn a gain only from slot machines whose arms have been actually pulled. A similar precondition is set also in the example of Non-Patent Document 1. However, in a case where the multi-armed bandit problem is applied to an actual problem different from slot machines, a gain may be earned not only from options that have been selected but also from options that have not been selected, depending on the type of the problem.

For example, in the above-described example involving a promotion, there are cases where not only a user to whom the promotion has been provided, but also a user to whom the promotion has not been provided purchase a product, and information of such purchase histories and the like is obtained. In such an example, it is favorable that a gain from an option that has not been selected be taken into consideration as well.

An optimization processing apparatus according to the following example embodiment uses an algorithm suitable for the multi-armed bandit problem, but also takes into consideration a gain from an option that has not been selected. Furthermore, the optimization processing apparatus according to the example embodiment estimates a gain function while taking into consideration the fact that a reliability degree function has been estimated optimistically. As a result, the accuracy of optimization can be increased.

### Example Embodiment

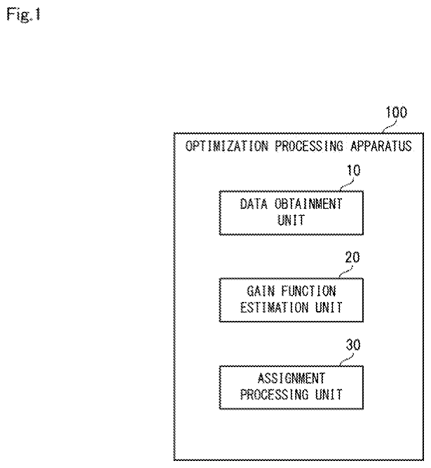

The following describes an optimization processing apparatus, an optimization processing method, and a program according to an example embodiment with reference to FIG. 1 to FIG. 6.

[Apparatus Configuration]

First, a schematic configuration of the optimization processing apparatus according to the example embodiment will be described using FIG. 1. FIG. 1 is a block diagram showing a schematic configuration of the optimization processing apparatus according to the example embodiment.

An optimization processing apparatus 100 shown in FIG. 1 is an apparatus for assigning actions on a per-user basis. As shown in FIG. 1, the optimization processing apparatus 100 includes a data obtainment unit 10, a gain function estimation unit 20, and an assignment processing unit 30.

The data obtainment unit 10 obtains constraint information on a per-action basis, and user information on a per-user basis. For each user, the gain function estimation unit 20 estimates a prediction function and a reliability degree function based on the constraint information and the user information obtained by the data obtainment unit 10. The prediction function predicts a gain earned from the user, and the reliability degree function derives a reliability degree of the result of prediction made by the prediction function.

Furthermore, for each user, the gain function estimation unit 20 estimates a gain function indicating a gain earned from the user, from the estimated prediction function and reliability degree function. Moreover, for each user, the gain function estimation unit 20 corrects the gain function of the user in a case where a set condition has been satisfied. The assignment processing unit 30 assigns actions on a per-user basis based on the gain functions estimated by the gain function estimation unit 20.

In this way, according to the example embodiment, while an action is assigned to each user based on the gain functions that have been estimated on a per-user basis, the gain functions corresponding to respective users are corrected under a certain condition. Therefore, according to the example embodiment, the accuracy of optimization at the time of assignment of an action to a user is increased.

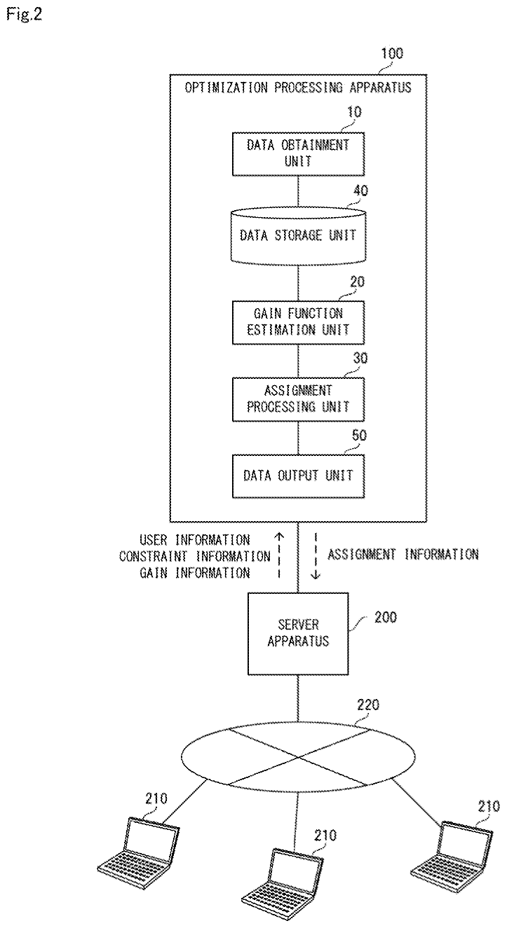

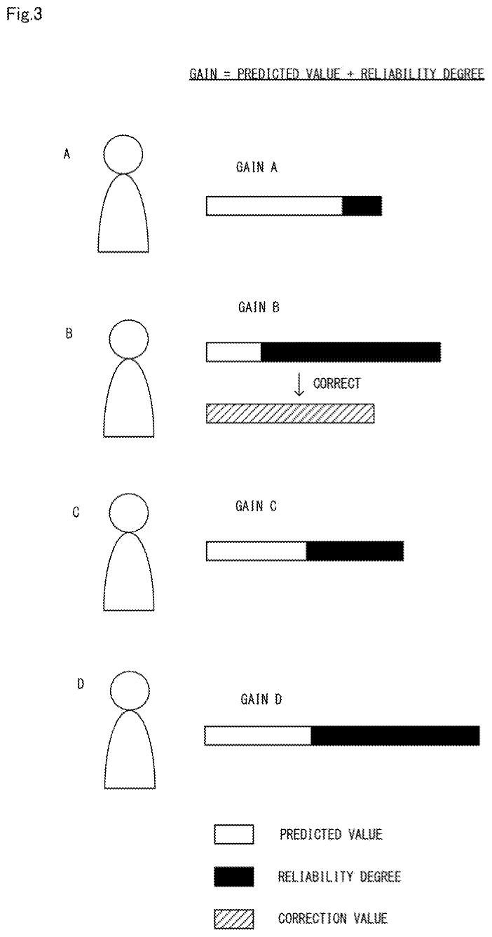

Next, with use of FIG. 2 and FIG. 3, the configuration and functions of the optimization processing apparatus 100 according to the example embodiment will be specifically described. FIG. 2 is a block diagram specifically showing the configuration of the optimization processing apparatus according to the example embodiment.

Below, the optimization processing apparatus 100 according to the example embodiment is used to determine how to assign promotions for selling products, as actions, to a plurality of users who have been registered in advance. Therefore, below, an “action” is also expressed as a “promotion”.

For example, assume that a promotion is direct mail. In this case, the optimization processing apparatus 100 determines, through optimization, to which user direct mail is to be sent among the registered users. In this example, there are cases where direct mail cannot be sent to every user because, for example, there are too many users, and the number of pieces of direct mail that can be sent is a constraint condition for action assignment.

In the following description, it is assumed that there is one type of promotion, and it is assumed that the measure that can executed with respect to each user is one of provision of the promotion and non-provision of the promotion, unless specifically stated otherwise. Note that in the example embodiment, there may be multiple types of promotions.

First, as shown in FIG. 2, in the example embodiment, the optimization processing apparatus 100 is connected to a server apparatus 200 that executes promotions (actions) with respect to terminal apparatuses 210 of respective users. Specifically, the server apparatus 200 distributes an advertisement, which is a promotion for a product, to a terminal apparatus 210 of a user based on the result of assignment by the optimization processing apparatus 100. Also, the server apparatus 200 is connected to the terminal apparatuses 200 via a network 220, such as the Internet.

Furthermore, as shown in FIG. 2, in the example embodiment, the optimization processing apparatus 100 includes a data storage unit 40 and a data output unit 50, in addition to the data obtainment unit 10, the gain function estimation unit 20, and the assignment processing unit 30 that have been described earlier.

In the example embodiment, for example, the data obtainment unit 10 obtains user information on a per-user basis and constraint information on a per-action basis from the server apparatus 200, and stores the obtained user information and constraint information into the data storage unit 40. Here, user information is information related to a user, and includes, for example, information such as a user ID (Identifier), a history of promotions assigned to the user, a history of products purchased by the user, the age of the user, and so on.

Also, constraint information is information related to the constraints at the time of provision of a promotion, and includes, for example, such information as the upper limit of the number of users to whom the promotion can be provided, the type of the promotion that can be provided, and so on.

Furthermore, in the example embodiment, the data obtainment unit 10 also obtains, for each user, gain information that specifies a gain earned from the user (e.g., the price of a product purchased by the user, etc.) after a promotion has been assigned. For each user, the data obtainment unit 10 stores the obtained gain information into the data storage unit 40 in association with the corresponding user information.

In the example embodiment, the gain function estimation unit 20 first estimates a prediction function for each user, through machine learning, by using the user information of each user and the gain information associated therewith, which are stored in the data storage unit 40, as training data. The prediction function uses the user information as an input, and outputs a predicted value of a gain.

In addition, for each user, the gain function estimation unit 20 calculates a predicted value by inputting the user information to the estimated prediction function, and further divides the calculated predicted value by a gain specified by the gain information stored in the data storage unit 40, thereby calculating a reliability degree. Then, the gain function estimation unit 20 performs machine learning by using the calculated predicted value and reliability degree as training data, and estimates a reliability degree function for each user. The reliability degree function uses the predicted value as an input, and outputs a reliability degree of the predicted value. Thereafter, the gain function estimation unit 20 estimates (constructs) a gain function with use of the following Math. 1.

Gain function=prediction function+reliability degree function [Math. 1]

Specifically, provided that the user's feature obtained from the user information of user i is xₜ(i) and a gain earned from user i is rₜ(i), for example, the prediction function is represented by Math. 2, the reliability degree function is represented by Math. 3, and the gain function is represented by Math. 4. Note that in Math. 2, θₜ(i) is a function obtained through machine learning. Similarly, in Math. 3, Vₜ(i) is a function obtained through machine learning. In Math. 3, αₜ is a no particular coefficient.

Prediction function=\hat{θ}ₜ^{T}xₜ(i) [Math. 2]

Reliability degree function=αₜ\sqrt{xₜ(i)^{T}Vₜ⁻¹xₜ(i)} [Math. 3]

Gain function=\hat{r}ₜ(i)=\hat{θ}ₜ^{T}xₜ(i)+αₜ\sqrt{xₜ(i)^{T}Vₜ⁻¹xₜ(i)} [Math. 4]

As described earlier, the reliability degree function in the above Math. 3 is estimated through machine learning that uses, as training data, a predicted value obtained by inputting the user information to the prediction function and the gain information of each user. Therefore, the reliability degree function in the above Math. 3 is an optimistic function with which a high reliability degree is estimated in the case of an uncertain option.

Also, in the example embodiment, as shown in FIG. 3, the gain function estimation unit 20 calculates a reliability degree for each user by assigning the user information of the user to the reliability degree function, and in a case where the calculated reliability degree is higher than a threshold, corrects the gain function corresponding to the pertinent user to a fixed value.

FIG. 3 is a diagram for describing processing for correcting a gain function according to the example embodiment. In the example of FIG. 3, among users A to D, only user B has a reliability degree with a value higher than the threshold. As the reliability degree function is an optimistic function as described earlier, using the gain function of user B as is leads to a situation where a promotion is not provided to a user from whom a high gain is supposed to be earned. For this reason, the gain function estimation unit 20 executes a correction to replace the gain function of user B with a fixed value.

In the example embodiment, the assignment processing unit 30 assigns promotions on a per-user basis based on the gain functions estimated by the gain function estimation unit 20. Specifically, the assignment processing unit 30 calculates a gain by applying the user information to the gain function for each user who acts as a candidate targeted for the promotion, and determines a user to be targeted for the promotion in accordance with the calculated gains.

Based on the result of assignment by the assignment processing unit 30, the data output unit 50 generates assignment information indicating which promotion has been assigned to which user, and transmits the generated assignment information to the server apparatus 200.

In this way, the server apparatus 200, for example, distributes an advertisement as a promotion to a terminal apparatus 210 of a user in accordance with the assignment information. Then, the server apparatus 200 obtains a purchase history of the user after the promotion from, for example, a management server such as an EC site, and calculates a gain earned from the user based on the obtained purchase history. Thereafter, the server apparatus 200 transmits gain information to the optimization processing apparatus 100.

[Apparatus Operations]

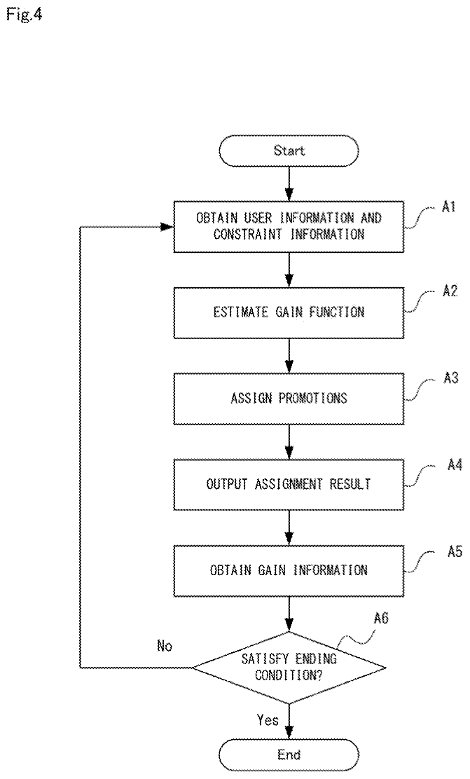

Next, the operations of the optimization processing apparatus according to the example embodiment will be described using FIG. 4. FIG. 4 is a flow diagram showing the operations of the optimization processing apparatus according to the example embodiment. In the following description, FIG. 1 to FIG. 3 will be referred to as appropriate. Also, in the example embodiment, the optimization processing method is implemented by causing the optimization processing apparatus 100 to operate. Therefore, the following description of the operations of the optimization processing apparatus 100 also applies to the optimization processing method according to the example embodiment.

First, as shown FIG. 4, the data obtainment unit 10 obtains, from the server apparatus 200, user information on a per-user basis and constraint information on a per-promotion basis (step A1). Also, the data obtainment unit 10 stores the obtained user information and constraint information into the data storage unit 40.

Next, for each user, the gain function estimation unit 20 estimates a prediction function and a reliability degree function based on the constraint information and the user information stored in the data storage unit 40, and further estimates a gain function with use of these (step A2).

Next, based on the gain functions of respective users estimated in step A2, the assignment processing unit 30 assigns promotions on a per-user basis (step A3). Specifically, the assignment processing unit 30 calculates a gain by applying the user information to the gain function on a per-user basis, and determines a user to be targeted for a promotion in accordance with the calculated gains.

Next, based on the result of assignment in step A3, the data output unit 50 generates assignment information indicating which promotion has been assigned to which user, and transmits the generated assignment information to the server apparatus 200 (step A4).

As a result of the execution of step A4, the server apparatus 200 consequently distributes an advertisement as a promotion to a terminal apparatus 210 of a user in accordance with the assignment information. Then, the server apparatus 200 obtains a purchase history of the user after the promotion from a management server such as an EC site, and calculates a gain earned from the user based on the obtained purchase history. Thereafter, the server apparatus 200 transmits gain information of each user to the optimization processing apparatus 100.

Next, once gain information has been transmitted from the server apparatus 200, the data obtainment unit 10 obtains the same (step A5). Also, for each user, the data obtainment unit 10 stores the obtained gain information into the data storage unit 40 in association with the corresponding user information.

Thereafter, the data obtainment unit 10 determines whether an ending condition is satisfied with regard to the sequence of processing (step A6). Examples of the ending condition include a condition where an ending instruction has been issued from the outside, and a condition where steps A1 to A5 have been executed a predetermined number of times.

In a case where it is determined that the ending condition is not satisfied (Step A6: No), the data obtainment unit 10 executes step A1 again. Unless the ending condition is satisfied, steps A1 to A6 are executed repeatedly. On the other hand, in a case where the ending condition is satisfied (step A6: Yes), processing in the optimization processing apparatus 100 ends. As such, unless the ending condition is satisfied, steps A1 to A6 are executed repeatedly.

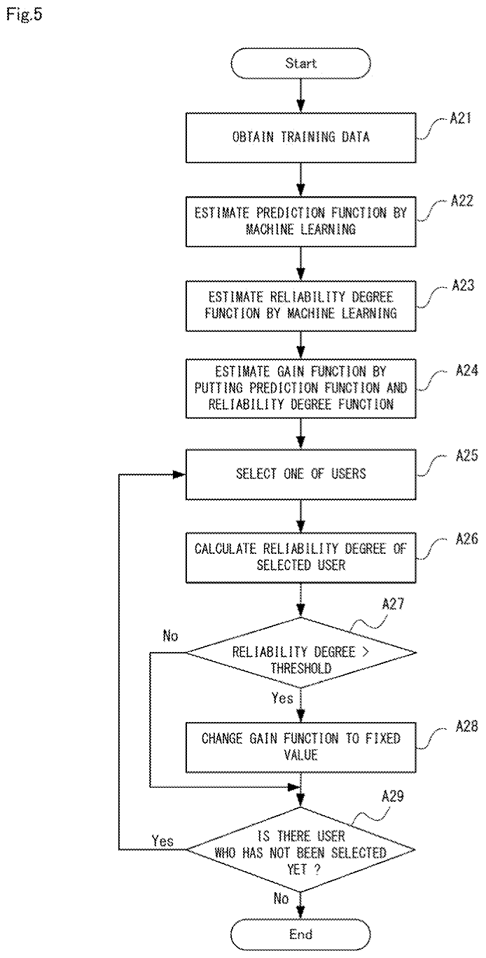

Now, processing for estimating a gain function shown in FIG. 4 (step A2) will be described more specifically using FIG. 5. FIG. 5 is a flow diagram that more specifically shows processing for estimating a gain function shown in FIG. 4.

As shown in FIG. 4, first, the gain function estimation unit 20 obtains user information of each user and gain information associated therewith, which are stored in the data storage unit 40, as training data (step A21).

The gain information obtained in step A21 is gain information that was obtained in step A5 executed before. Note that in a case where step A5 has not been executed yet, sample data of gain information that has been prepared in advance may be used.

Next, the gain function estimation unit 20 estimates a prediction function for each user by executing machine learning while using the user information and the gain information obtained in step A21 as training data (step A22).

Next, the gain function estimation unit 20 calculates a predicted value by inputting the user information to the prediction function estimated in step A22, and further divides the calculated predicted value by a gain specified by the gain information obtained in step A21, thereby calculating a reliability degree. Then, the gain function estimation unit 20 performs machine learning by using the calculated predicted value and reliability degree as training data, and estimates a reliability degree function for each user (step A23).

Next, the gain function estimation unit 20 estimates a gain function by putting the prediction function estimated in step A22 and the reliability degree function estimated in step A23 into the aforementioned Math. 1 (step A24).

Next, the gain function estimation unit 20 selects one of the users for whom the user information was obtained in step A1 (step A25).

Next, with respect to the user selected in step A25, the gain function estimation unit 20 calculates a reliability degree by assigning the user information to the reliability degree function estimated in step A24 (step A26).

Next, the gain function estimation unit 20 determines whether the reliability degree calculated in step A26 is higher than a threshold (step A27).

Then, in a case where the reliability degree is higher than the threshold as a result of the determination in step A27 (step A27: Yes), the gain function estimation unit 20 changes the gain function for the user selected in step A25 to a fixed value (step A28). On the other hand, in a case where the reliability degree is not higher than the threshold as a result of the determination in step A27 (step A27: No), step A29 is executed.

After step A28 has been executed, or in a case where step A27 results in No, the gain function estimation unit 20 determines whether the users for whom the user information was obtained in step A1 include a user who has not been selected yet in step A25 (step A29).

In a case where there is a user who has not been selected yet as a result of the determination in step A29, the gain function estimation unit 20 executes step A25 again. On the other hand, in a case where there is no user who has not been selected yet as a result of the determination in step A29, step A2 ends, and step A3 is executed thereafter.

### Advantageous Effects of Example Embodiment

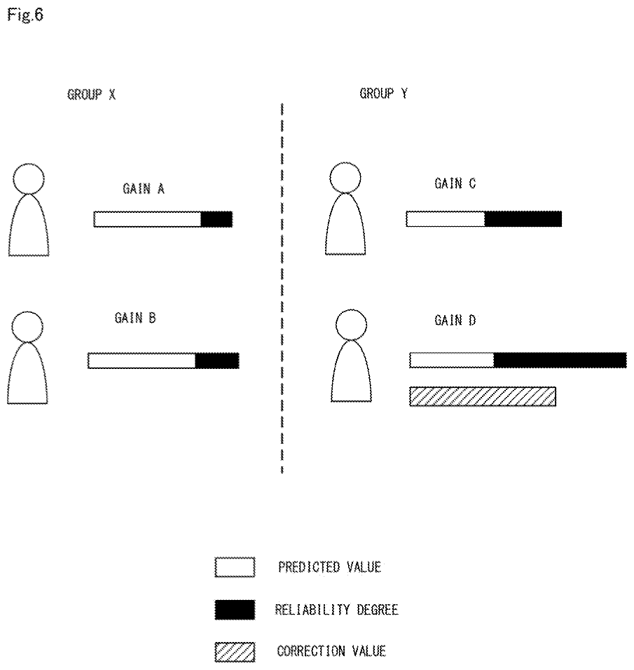

Now, for example, assume a case where it is necessary to determine one of group X and group Y as a target of a promotion as shown in FIG. 6. FIG. 6 is a diagram showing an example of application of the optimization processing apparatus according to the example embodiment.

Assume that, in the example of FIG. 6, there is a user whose reliability degree is higher than the threshold in one of the groups. At this time, in the example embodiment, while a promotion is assigned to each user based on the gain functions that have been estimated on a per-user basis, the gain function of the user whose reliability degree is too high is corrected. Therefore, according to the example embodiment, the accuracy of optimization at the time of assignment of a promotion to a user is increased.

[Program]

It suffices for a program in the example embodiment to be a program that causes a computer to carry out steps A1 to A6 illustrated in FIG. 4. Also, by this program being installed and executed in the computer, the optimization processing apparatus and the optimization processing method according to the example embodiment can be realized. In this case, a processor of the computer functions and performs processing as the data obtainment unit 10, the gain function estimation unit 20, the assignment processing unit 30 and the data output unit 50.

In the example embodiment, the data storage unit 40 may be realized by storing the data files constituting this in a storage device such as a hard disk provided in the computer. Also, the data storage unit 40 may be realized by a storage device of another computer. The computer includes general-purpose PC, smartphone and tablet-type terminal device.

Furthermore, the program according to the example embodiment may be executed by a computer system constructed with a plurality of computers. In this case, for example, each computer may function as one of the data obtainment unit 10, the gain function estimation unit 20, the assignment processing unit 30 and the data output unit 50.

[Physical Configuration]

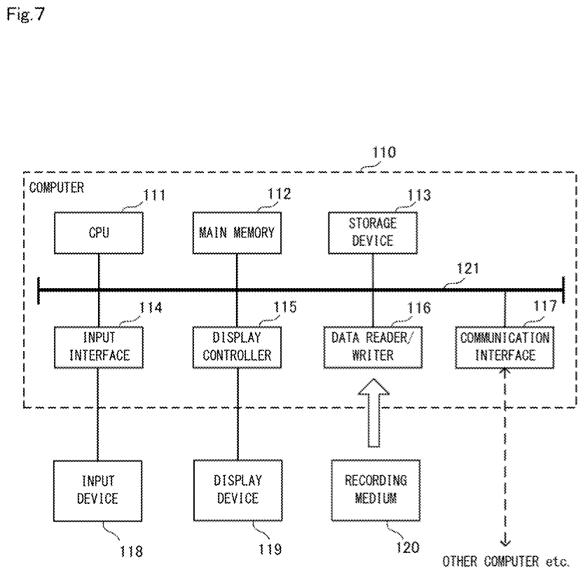

Using FIG. 7, the following describes a computer that realizes the optimization processing apparatus 100 by executing the program according to the example embodiment. FIG. 7 is a block diagram illustrating an example of a computer that realizes the optimization processing apparatus according to the example embodiment.

As shown in FIG. 7, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the programs according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the optimization processing apparatus 100 according to the example embodiment can also be realized by using items of hardware that respectively correspond to the components, rather than the computer in which the program is installed. Furthermore, a part of the optimization processing apparatus 100 may be realized by the program, and the remaining part of the optimization processing apparatus 100 may be realized by hardware.

A part or an entirety of the above-described example embodiment can be represented by (Supplementary Note 1) to (Supplementary Note 6) described below, but is not limited to the description below.

(Supplementary Note 1)

An optimization processing apparatus for assigning actions on a per-user basis, the optimization processing apparatus comprising:

a data obtainment unit that obtains constraint information on a per-action basis and user information on a per-user basis;

a gain function estimation unit estimates, for each user, a prediction function and a reliability degree function based on the constraint information and the user information, and estimates a gain function from the estimated prediction function and the reliability degree function, the prediction function predicting a gain earned from the user, the reliability degree function deriving a reliability degree of a result of prediction made by the prediction function, and the gain function indicating a gain earned from the user; and

an assignment processing unit that assigns the actions on a per-user basis based on the estimated gain functions,

wherein

for each user, the gain function estimation unit corrects the gain function of the user in a case where a set condition is satisfied.

(Supplementary Note 2)

The optimization processing apparatus according to Supplementary Note 1, wherein

the gain function estimation unit calculates a reliability degree for each user by assigning the user information of the user to the reliability degree function, and corrects the gain function of the user to a fixed value in a case where the calculated reliability degree is higher than a threshold.

(Supplementary Note 3)

An optimization processing method for assigning actions on a per-user basis, the optimization processing method comprising:

a data obtainment step of obtaining constraint information on a per-action basis and user information on a per-user basis;

a gain function estimation step of estimating, for each user, a prediction function and a reliability degree function based on the constraint information and the user information, and estimating a gain function from the estimated prediction function and the reliability degree function, the prediction function predicting a gain earned from the user, the reliability degree function deriving a reliability degree of a result of prediction made by the prediction function, and the gain function indicating a gain earned from the user;

a correction step of correcting, for each user, the gain function of the user in a case where a set condition is satisfied; and

an assignment processing step of assigning the actions on a per-user basis based on the estimated gain functions.

(Supplementary Note 4)

The optimization processing method according to Supplementary Note 3, wherein

in the correcting step, a reliability degree is calculated for each user by assigning the user information of the user to the reliability degree function, and the gain function of the user is corrected to a fixed value in a case where the calculated reliability degree is higher than a threshold.

(Supplementary Note 5)

A computer readable recording medium that includes a program recorded thereon, the program being for causing a computer to assign actions on a per-user basis and including instructions that cause the computer to carry out:

a data obtainment step of obtaining constraint information on a per-action basis and user information on a per-user basis;

a gain function estimation step of estimating, for each user, a prediction function and a reliability degree function based on the constraint information and the user information, and estimating a gain function from the estimated prediction function and the reliability degree function, the prediction function predicting a gain earned from the user, the reliability degree function deriving a reliability degree of a result of prediction made by the prediction function, and the gain function indicating a gain earned from the user;

a correction step of correcting, for each user, the gain function of the user in a case where a set condition is satisfied; and

an assignment processing step of assigning the actions on a per-user basis based on the estimated gain functions.

(Supplementary Note 6)

The computer readable recording medium according to Supplementary Note 5, wherein

in the correcting step, a reliability degree is calculated for each user by assigning the user information of the user to the reliability degree function, and the gain function of the user is corrected to a fixed value in a case where the calculated reliability degree is higher than a threshold.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the present invention, it is possible to increase the accuracy of optimization at the time of assignment of an action to a user. The present invention is useful for a system or the like that promotes sales to users.

### REFERENCE SIGNS LIST

10 Data obtainment unit
20 Gain function estimation unit
30 Assignment processing unit
40 Data storage unit
50 Data output unit
100 Optimization processing apparatus
200 Server apparatus
210 Terminal apparatus
220 Net work
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An optimization processing apparatus for assigning actions on a per-user basis, the optimization processing apparatus comprising:
at least one memory storing instructions; and
at least one processor configured to execute the instructions to:
obtain constraint information on a per-action basis and user information on a per-user basis;
estimate, for each user, a prediction function and a reliability degree function based on the constraint information and the user information, and estimate a gain function from the estimated prediction function and the reliability degree function, the prediction function predicting a gain earned from the user, the reliability degree function deriving a reliability degree of a result of prediction made by the prediction function, and the gain function indicating a gain earned from the user;
corrects the gain function of the user in a case where a set condition is satisfied; and
assign the actions on a per-user basis based on the estimated gain functions.

2. The optimization processing apparatus according to claim 1, wherein further at least one processor configured to execute the instructions to:
calculate a reliability degree for each user by assigning the user information of the user to the reliability degree function, and corrects the gain function of the user to a fixed value in a case where the calculated reliability degree is higher than a threshold.

3. An optimization processing method for assigning actions on a per-user basis, the optimization processing method comprising:
obtaining constraint information on a per-action basis and user information on a per-user basis;
for each user, estimating a prediction function and a reliability degree function based on the constraint information and the user information, and estimating a gain function from the estimated prediction function and the reliability degree function, the prediction function predicting a gain earned from the user, the reliability degree function deriving a reliability degree of a result of prediction made by the prediction function, and the gain function indicating a gain earned from the user;
for each user, correcting the gain function of the user in a case where a set condition is satisfied; and
assigning the actions on a per-user basis based on the estimated gain functions.

4. The optimization processing method according to claim 3, wherein
in the correcting, a reliability degree is calculated for each user by assigning the user information of the user to the reliability degree function, and the gain function of the user is corrected to a fixed value in a case where the calculated reliability degree is higher than a threshold.

5. A non-transitory computer readable recording medium that includes a program recorded thereon, the program being for causing a computer to assign actions on a per-user basis and including instructions that cause the computer to carry out:
obtaining constraint information on a per-action basis and user information on a per-user basis;
for each user, estimating a prediction function and a reliability degree function based on the constraint information and the user information, and estimating a gain function from the estimated prediction function and the reliability degree function, the prediction function predicting a gain earned from the user, the reliability degree function deriving a reliability degree of a result of prediction made by the prediction function, and the gain function indicating a gain earned from the user;
for each user, correcting the gain function of the user in a case where a set condition is satisfied; and
assigning the actions on a per-user basis based on the estimated gain functions.

6. The non-transitory computer readable recording medium according to claim 5, wherein
in the correcting, a reliability degree is calculated for each user by assigning the user information of the user to the reliability degree function, and the gain function of the user is corrected to a fixed value in a case where the calculated reliability degree is higher than a threshold.
